(19) United States
(12) Patent Application Publication
(10) Pub. No.: US 2020/0191106 A1
(43) Pub. Date: Jun. 18, 2020

(54) INJECTOR HOLDER

(71) Applicant: USUI CO., LTD., Sunto-gun, Shizuoka (JP)

(72) Inventor: Hiroyuki NISHIZAWA, Sunto-gun, Shizuoka (JP)

(21) Appl. No.: 16/621,249

(22) PCT Filed: May 1, 2018
(86) PCT No.: PCT/JP2018/017372

§ 371 Date: Dec. 11, 2019

(30) Foreign Application Priority Data
Jul. 6, 2017 (JP) 2017-132721

(51) Int. Cl. F02M 61/14

(52) U.S. Cl. CPC F02M 61/14; F02M 61/168; F02M 2200/858

(57) ABSTRACT

The present invention aims for smoothly aligning an injector and an injector holder in a circumferential direction when the injector is assembled to the injector holder. In an injector holder 1 having an injector cup 2 for inserting an injector 8 into the injector cup 2 and an annular flange 3 projecting outward from an opening edge of the injector cup 2, an engaging recess piece 4 is extended from the annular flange 3, the engaging recess piece 4 having a recess 6 capable of being engaged with an engaging protrusion 16 protruded from the injector 8 for positioning the injector 8, and a claw portion 7 extending in a direction of assembling the injector 8 is projected from the tip of the engaging recess piece 4.

### TECHNICAL FIELD

The present invention relates to an injector holder for inserting an injector used for an MPI delivery pipe, a rail for a gasoline direct injection engine, or the like of an automobile.

### BACKGROUND ART

In a conventional injector holder (32) for inserting an injector (31) as shown in FIG. 1 of Patent Document 1, in order to prevent the rotation of the injector (31), an engaging recess piece (35) having a recess (34) is extended from an annular flange (33) protruding from an opening edge of an injector cup (41) is already known as shown in FIG. 4. The injector (31) is inserted and arranged in the injector holder (32) in a state that an engaging protrusion (36) protruding from the injector (31) is engaged with the recess (34) of the engagement recess piece (35) as shown in FIGS. 4 and 5 of the present invention and FIG. 1 of Patent Document 2. As a result, since the recess (34) and the engaging protrusion (36) are engaged with each other, the injector (31) can be prevented from rotating with respect to the injector holder (32).
Patent Document 1: Japanese Patent No. 4415902
Patent Document 2: Japanese Patent No. 3715253

### DISCLOSURE OF THE INVENTION

### Problems to be Solved by the Invention

When the above described injector (31) is inserted into the conventional injector holder (32), the tip opening (37) side of the injector (31) is arranged at a deep position inside the injector holder (32) as shown in FIG. 5. Therefore, an O-ring (38) provided on the outer periphery of the tip opening (37) of the injector holder (32) is arranged in close contact with an inner peripheral surface (40) of the injector holder (32).

Furthermore, when the injector (31) is assembled to the injector holder (32), if the engaging recess piece (35) of the injector holder (32) and the engaging protrusion (36) of the injector (31) are displaced with each other in a circumference direction and the engaging protrusion (36) abuts the engaging recess piece (35) of the injector holder (32) as shown in FIG. 6, it is necessary to pull the injector (31) out of the injector holder (32) once to check the position between the injector (31) and the injector holder (32) in the circumferential direction and necessary to insert the injector (31) in the injector holder (32) again to correct the position.

However, in a state that the engaging protrusion (36) of the injector (31) and the engaging concave piece (35) of the injector holder (32) are in contact with each other as described above, the tip opening (37) side of the injector (31) is inserted deeply into the injector holder (32) as shown in FIG. 6, and the O-ring (38) of the injector (31) and the inner peripheral surface (40) of the injector holder (32) are in close contact with each other.

Therefore, when reassembling the injector (31) and the injector holder (32), it is necessary to pull out the injector (31) from the injector holder (32). However, since the pulling load is large when the injector (31), which is in close contact with the injector holder (32) via the O-ring (38), is pulled out from the injector holder (32), the O-ring (38) is damaged by the friction of the pulling-out operation.

Accordingly, when the position between the engaging protrusion (36) of the injector (31) and the recess (34) of the injector holder (32) are displaced with each other during the assembling process, additional work is required for pulling out the injector (31) from the injector holder (32), and the O-ring (38) is damaged as a result of the pulling-out operation. Thus, the replacement of the O-ring (38) is required and workability is remarkably lowered.

The present invention aims for solving the above mentioned problems. Thus, the present invention aims for smoothly aligning the injector and the injector holder in the circumferential direction when the injector is assembled to the injector holder.

### Means for Solving the Problem

The present invention is made for solving the above mentioned problems, and the present invention is based on an injector holder having an injector cup for inserting an injector and an annular flange protruding outward from an opening edge of the injector cup. The injector holder having the above described configuration is generally used for an injector for an MPI (Multi Point Injection) engine.

An engaging recess piece is extended from the annular flange, and the engaging recess piece has a recess capable of being engaged with an engaging protrusion protruded from the injector for positioning the injector, a claw portion extending in a direction of assembling the injector is protruded from the tip of the engaging recess piece, and the tip of the claw portion is configured to abut the engaging protrusion when the injector and the injector cup are displaced with each other in a circumference direction on the way of inserting the injector into the injector cup.

### Effects of the Invention

As described above, according to the present invention, since the claw portion extending in the direction of assembling the injector is protruded from the tip of the engaging recess piece, when the injector is inserted and arranged in the injector holder, the engaging protrusion of the injector first comes into contact with the claw portion of the injector holder if the positional deviation in the circumferential direction occurs.

At this time, since the claw portion of the injector holder extends from the annular flange of the injector holder in the direction of assembling the injector, the tip opening of the injector remains at a shallow position without entering into a deep position inside the injector holder (1). Thus, the O-ring arranged on the outer periphery of the tip of the injector also remains at a shallow position in the injector holder.

Therefore, it is possible to prevent the situation where the O-ring arranged on the injector is in close contact with the inner circumference of the injector holder and the injector is difficult to be pulled out of the injector holder. Accordingly, when the injector and the injector holder are displaced with each other in the circumferential direction, the injector can be easily pulled out from the injector holder and the damage of the O-ring caused by the pulling can be reduced. Thus, the replacement of the O-ring can be avoided and the O-ring can be continuously used.

### BRIEF DESCRIPTION OF THE DRAWINGS

FIG. 1 is a perspective view showing the first embodiment of the present invention.

FIG. 2 is a partial cross-sectional view of the first embodiment.

FIG. 3 is a partially enlarged cross-sectional view during the assembling process of the first embodiment.

FIG. 4 is a perspective view of the conventional example.

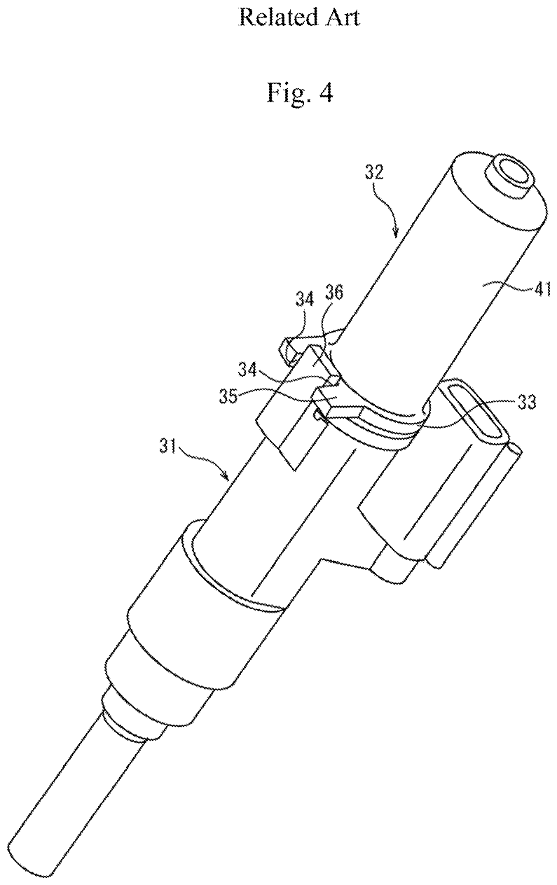

FIG. 5 is a partial cross-sectional view of the conventional example.

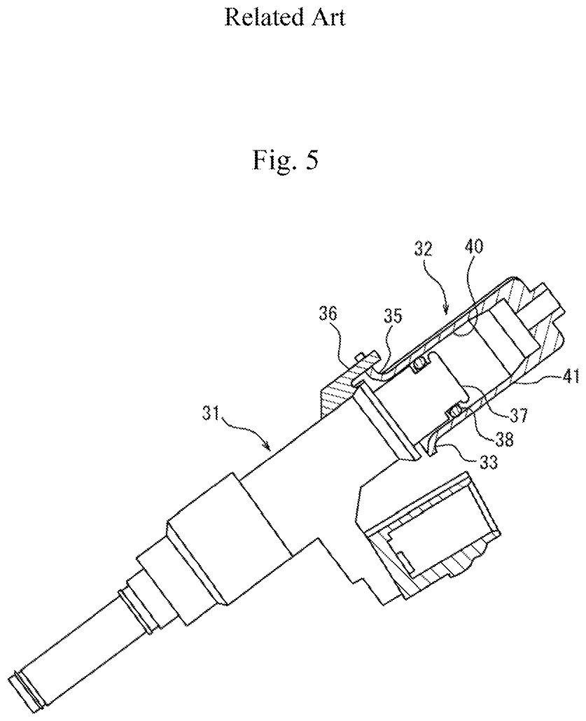

FIG. 6 is a partially enlarged cross-sectional view during the assembling process of the conventional example.

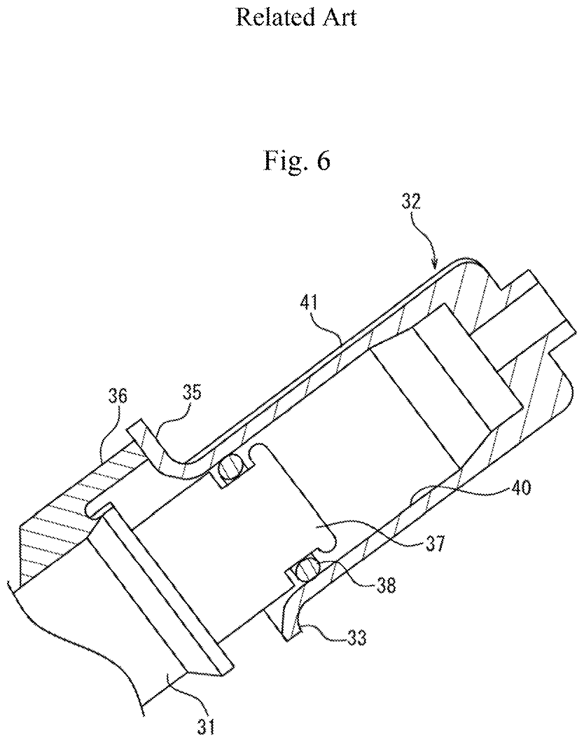

### MODES FOR CARRYING OUT THE INVENTION

### First Embodiment

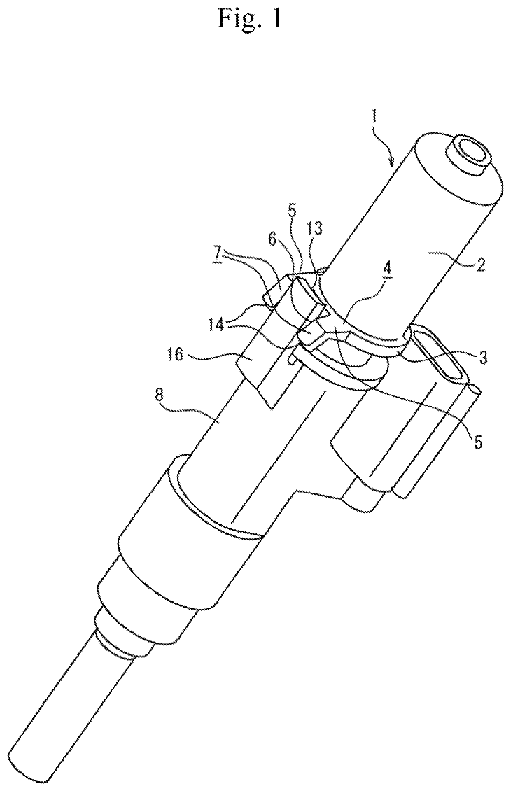

The first embodiment of the present invention will be described below with reference to FIGS. 1 to 3. First, (1) is an injector holder, and the injector holder (1) has an injector cup (2) and an annular flange (3) projecting outward from an outer peripheral edge of the injector cup (2). An engaging recess piece (4) is extended from the annular flange (3). The engaging recess piece (4) includes a pair of projecting pieces (5) and a U-shaped recess (6) provided between the pair of projecting pieces (5). A claw portion (7) is extended from the tip of the projecting piece (5) of the engaging recess piece (4). The claw portion (7) is protruded from the protrusion piece (5) to extend from the protrusion piece (5) in a state of being bent from the protrusion direction of the protrusion piece (5) to the injector (8) side.

The engaging protrusion (16) of the injector (8) is capable of being engaged with the recess (6) of the engagement recess (4). The engaging protrusion (16) is L-shaped in cross section, and the engaging protrusion (16) is provided on the outer peripheral surface of the injector (8) on the tip opening (10) side as shown in FIG. 1. The tip side of the engaging protrusion (16) is protruded toward the injector holder (1) to which the injector (8) is assembled.

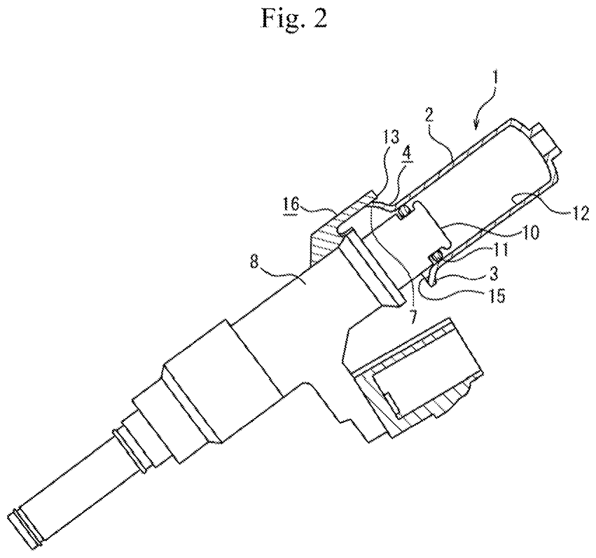

As shown in FIG. 1, the injector holder (1) can be assembled to the injector (8) in a state that the engaging protrusion (16) is arranged and engaged in the recess (6) of the injector holder (1). At this time, as shown in FIG. 2, the O-ring (11) provided on the outer periphery of the tip opening (10) of the injector (8) is arranged to be in close contact with the inner peripheral surface (12) of the injector holder (1). Accordingly, since the engaging protrusion (16) is engaged with the engaging recess piece (4) while the injector (8) is difficult to be pulled out of the injector holder (1), the injector (8) is assembled to the injector holder (1) in a state that the injector (8) is difficult to rotate with respect the injector holder (1)

When the injector (8) is assembled to the injector holder (1) at the correct position where the engaging protrusion (16) of the injector (8) is engaged with the engaging concave piece (4) of the injector holder (1) as described above, the assembling operation can be performed smoothly. However, when the injector (8) and the injector holder (1) are displaced in the circumferential direction during the assembling process, for example, the tip (13) of the engaging protrusion (16) of the injector (8) comes into contact with the tip (14) of the claw portion (7) of the injector holder (1) at the time when the tip opening (10) side of the injector (8) is inserted into the injector holder (1).

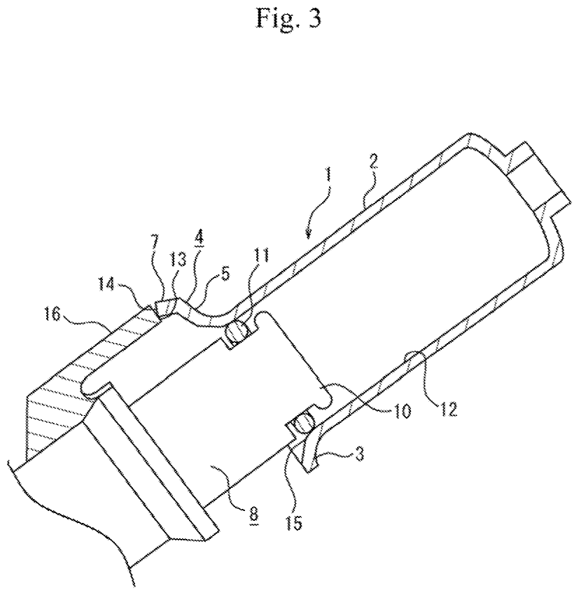

Here, as shown in FIG. 3, since the claw portion (7) is extended from the protrusion piece (5) in the direction of assembling the injector (8) as described above, the tip opening (10) of the injector (8) remains at a shallow position without entering into a deep position inside the injector holder (1) when the engaging protrusion (16) of the injector (8) and the claw portion (7) of the injector holder (1) abut with each other. Consequently, the O-ring (11) provided on the outer periphery of the tip of the injector (8) remains in the vicinity of the opening (15) of the injector holder (1) without coming into close contact with the inner peripheral surface (12) of the injector holder (1) as shown in FIG. 3.

Accordingly, when the injector (8) and the injector holder (1) are displaced with each other in the circumference direction as described above, the engaging protrusion (16) of the injector (8) comes into contact with the claw portion (7) of the injector holder (1), and the injector (8) can be easily pulled out of the injector holder (1) and the damage of the O-ring caused by the pulling can be prevented. Thus, the O-ring (11) can be continuously used without the need for replacement, which is economical.

### DESCRIPTION OF THE REFERENCE NUMERALS

1 injector holder

2 injector cup

3 annular flange

4 engaging recess piece

6 recess

7 claw portion

8 injector

14 tip

16 engaging protrusion

1. An injector holder comprising:
an injector cup for inserting an injector into the injector cup; and
an annular flange protruding outward from an opening edge of the injector cup, wherein
an engaging recess piece is extended from the annular flange, the engaging recess piece having a recess capable of being engaged with an engaging protrusion protruded from the injector for positioning the injector,
a claw portion extending in a direction of assembling the injector is protruded from the tip of the engaging recess piece, and
the tip of the claw portion is configured to abut the engaging protrusion when the injector and the injector cup are displaced with each other in a circumference direction on the way of inserting the injector into the injector cup.
